(19) United States
(12) Patent Application Publication
(10) Pub. No.: US 2022/0012046 A1
(43) Pub. Date: Jan. 13, 2022

(54) OS-INDEPENDENT PERIPHERAL PLUG-AND-PLAY AND DRIVER UPDATE METHOD FOR EMBEDDED SYSTEMS AND FIRMWARE DATA TRANSMISSION METHOD FOR EMBEDDED SYSTEM PLATFORM

(71) Applicant: Generalplus Technology Inc., Hsinchu City (TW)

(72) Inventors: Kung-Wang LEE, Hsinchu City (TW); Kai-Chao YANG, Hsinchu City (TW)

(21) Appl. No.: 17/104,815

(22) Filed: Nov. 25, 2020

(30) Foreign Application Priority Data
Jul. 10, 2020 (TW) 109123344

(51) Int. Cl. G06F 8/71; G06F 9/445; G06F 9/4401; G06F 8/654

(52) U.S. Cl. CPC G06F 8/71; G06F 8/654; G06F 9/4415; G06F 9/44505

(57) ABSTRACT

An OS-independent peripheral plug-and-play and driver update method for embedded system and firmware data transmission method for embedded system platform is provided. The method includes: determining whether a peripheral device is connected to the embedded system host; when the peripheral device is connected to the embedded system host, acquire the ID of the peripheral device; connecting to a firmware server; according to the ID, acquiring a driver; packing the driver into a firmware and transmitting to the embedded system host; and performing a firmware update.

This application claims priority of No. 109123344 filed in Taiwan R.O.C. on Jul. 10, 2020 under 35 USC 119, the entire content of which is hereby incorporated by reference.

### BACKGROUND OF THE INVENTION

### Field of the Invention

The invention relates to the embedded system technology, and more particularly to an OS-independent peripheral plug-and-play and driver update method for embedded system and firmware data transmission method for embedded system platform.

### Description of the Related Art

Plug-and-play is one of a basic function of desktop computer. When a peripheral device is inserted into a computer, the OS (operating system) would automatically detect its item model and search the driver. User does not need to manually set the configuration and install the driver. However, in an environment without an operating system or with a real-time operating system, the system does not have the capability of detection of peripheral device nor does it have the capability of driver installation. User has to manually package the main program and the driver to a firmware and then flash to the system. It is quite inconvenient for users who frequently change their peripheral devices. Developers and students may often need to replace different peripheral devices when the embedded system development board is adopted to develop their works. Every time the peripheral device is replaced, the driver and main program need to be manually flashed into the system. For users who are not familiar with embedded systems, it is a time-consuming and laborious task.

### BRIEF SUMMARY OF THE INVENTION

An objective of the invention is to provide an OS-independent peripheral plug-and-play and driver update method for embedded system and firmware data transmission method for embedded system platform, which simplify the driver installation process, especially for an embedded system without an operating system or with a real-time operating system. Users do not need to have knowledge of embedded system, and the driver installation can be performed through the firmware update program, a cloud database server and automatic installation process provided from the embodiment of the present invention such that the plug-and-play can be achieved. Therefore, the user who is not familiar with the embedded system can easily use it.

In view of this, the invention provides an OS-independent peripheral plug-and-play and driver update method for embedded system. The method comprises: determining whether an embedded system development board is electrically connected to a host PC; determining whether a peripheral device is electrically connected to the embedded system development board; when the peripheral device is electrically connected to the embedded system development board, acquiring the ID code of the peripheral device; connecting to a cloud database server; according to the ID code of the peripheral device, acquiring a driver of the peripheral device from the cloud database server; and performing a firmware update for the embedded system development board.

The present invention further provides a development system for embedded system. The development system comprises an embedded system development board, a host PC and a cloud database server. The cloud database server is for storing a plurality of drivers of peripheral devices. When a development board is electrically connected to the host PC, it is determined whether a peripheral device is electrically connected to the embedded system development board. When the peripheral device is electrically connected to the embedded system development board, an ID of the peripheral device is acquired and a connection between the cloud database server and the host PC is built. A driver is acquired from the cloud database server according to the ID of the peripheral device such that the firmware update is performed.

The OS-independent peripheral plug-and-play and driver update method for embedded system and the development system for embedded system according to a preferred embodiment of the present invention, the OS-independent peripheral plug-and-play and driver update method for embedded system according to claim 1, wherein the peripheral device comprises a CMOS sensing module. In a preferred embodiment of the present invention, performing a firmware update for the embedded system development board comprises: packing a firmware with the driver, and transmitting the firmware to the embedded system development board; and updating the embedded system development board by the firmware.

The OS-independent peripheral plug-and-play and driver update method for embedded system and the development system for embedded system according to a preferred embodiment of the present invention, wherein performing a firmware update for the embedded system development board comprises: transmitting the driver to the embedded system development board through a update program; and performing partial firmware update, wherein the driver in a cluster of a flash of the embedded system development board is updated.

The spirit of the invention is to perform the abovementioned steps, user only need to electrically connect the peripheral device to the embedded system development board, the host PC can download the driver by a specific program according to the ID of the peripheral device. And then according to the requirement, the driver may be packaged in to a firmware for performing firmware update or be transmitted to the embedded system development board to perform a partial update. It is convenient for users to increase the development speed and also reduces the burden on developers.

The above-mentioned and other objects, features and advantages of the present invention will become more apparent from the following detailed descriptions of preferred embodiments thereof taken in conjunction with the accompanying drawings.

### BRIEF DESCRIPTION OF THE SEVERAL VIEWS OF THE DRAWINGS

FIG. 1 illustrates a system block diagram depicting a development system for an embedded system according to a preferred embodiment of the present invention.

FIG. 2 illustrates a flow chart depicting an OS-independent peripheral plug-and-play and driver update method for embedded system according to a preferred embodiment of the present invention.

FIG. 3 illustrates a flow chart depicting an OS-independent peripheral plug-and-play and driver update method for embedded system according to a preferred embodiment of the present invention.

### DETAILED DESCRIPTION OF THE INVENTION

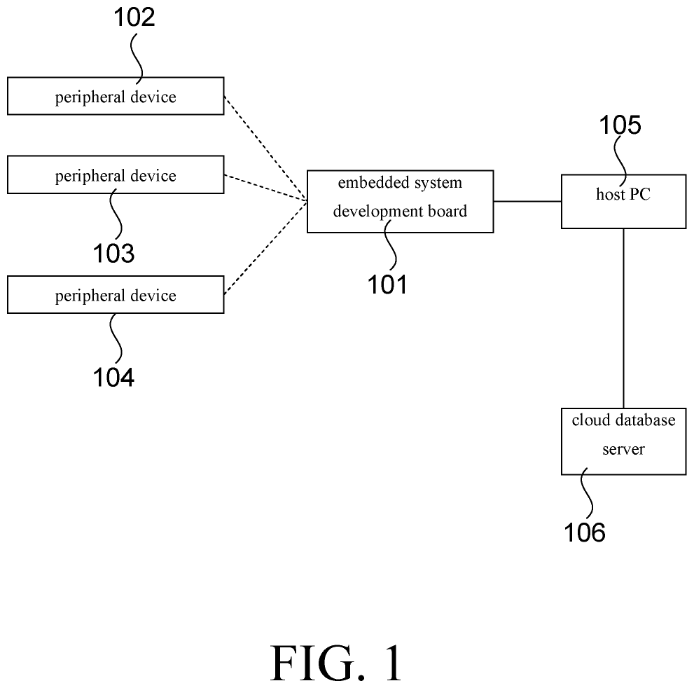

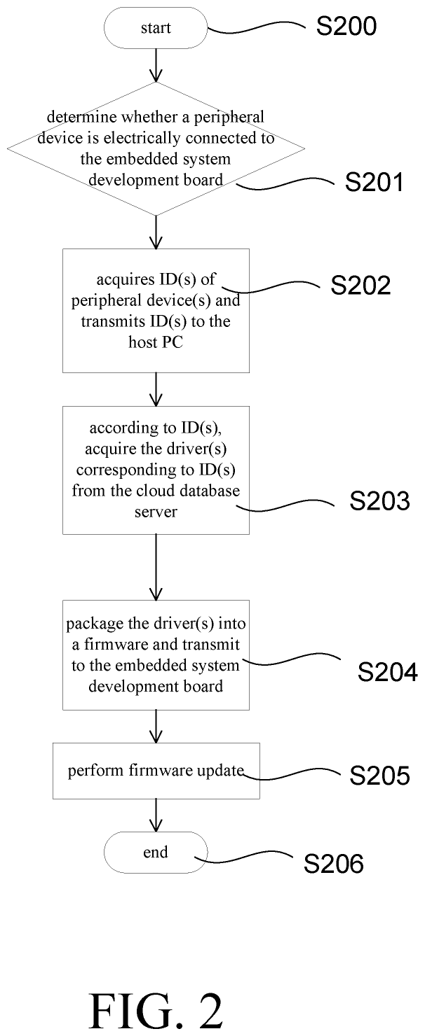

FIG. 1 illustrates a system block diagram depicting a development system for an embedded system according to a preferred embodiment of the present invention. FIG. 2 illustrates a flowchart depicting an OS-independent peripheral plug-and-play and driver update method for embedded system according to a preferred embodiment of the present invention. Referring to FIG. 1 and FIG. 2, the development system for embedded system in this embodiment includes an embedded system development board 101, a plurality of peripheral devices 102˜104, a host PC 105 and a cloud database server 106. The host PC 105 is electrically connected to the embedded system development board 101 and a firmware update program has been installed in the host PC 105 for acquiring drivers from the cloud database server 106. Further the firmware update program has the functions of integrating a firmware with driver(s) and downloading the firmware to the embedded system development board 101. The cloud database server 106 is for storing drivers of different peripheral devices. The peripheral devices 102˜104 may be servomotor, LCD module, CMOS sensor or internet module, etc.

In the prior art, since the driver installation procedures are pretty complex, user must has the experience of the embedded system development to install a driver of a peripheral devices. Generally speaking, in the prior art, user must introduce the driver library into the main program first, and add the initialization procedure, then recompile the program and package it into firmware, and finally flash it to the development board of the embedded system. Then, the peripheral device can be used after the embedded system is rebooted.

However, in the preferred embodiment of the present invention, the process becomes automatic. User can just link the embedded system development board 110 and the host PC 105, and open the firmware update program, and the firmware update program would automatically acquire the ID of the peripheral device electrically connected to the embedded system development board 110, and download the driver according to the ID of the peripheral device. The downloaded driver may be packaged into a firmware according to user's setting. Afterward, the firmware would be flashed into the embedded system development board 101 to accomplish the installation of the driver.

FIG. 2 illustrates a flow chart depicting an OS-independent peripheral plug-and-play and driver update method for embedded system according to a preferred embodiment of the present invention. Referring to FIG. 2, the OS-independent peripheral plug-and-play and driver update method includes the steps as follow.

In step S200, the method starts.

In step S201, it is determined whether a peripheral device is electrically connected to the embedded system development board 110.

In step S202, when a peripheral device is electrically connected to the embedded system development board 110, the embedded system development board 110 acquires the ID of the peripheral device and transmits the ID to the host PC 105. For example, user changes the CMOS sensor, the ID of the CMOS sensor would transmits to the development toolkits program of the host PC 105.

In step S203, according to the ID of the peripheral device, the driver corresponding to the ID is acquired from the cloud database server. The upgrade modules in the development toolkits program of the host PC 105 would search the driver in the cloud database server 106.

In step S204, the driver is packaged into a firmware and transmitted to the embedded system development board 110.

In step S205, a firmware update is performed in the embedded system development board to accomplish the driver installation. Accordingly, the upgrade modules in the development toolkits program of the host PC 105 would package the driver and the main system program into a firmware, and transmit to the embedded system development board 110, then flash it on the embedded system development board 110. In those procedures, user does not need to operate the program of the embedded system and does not need to manually package the firmware. Therefore, the new CMOS sensor can operate normally, and the plug-and-play is achieved.

In step S206, the method ends.

The upgrade module may be a firmware update program installed in the host PC 105 for example. When the host PC 105 is electrically connected to the embedded system development board 101 and the firmware update program is performed, the steps S200˜S206 would be performed. Thus, the firmware update program searches the newest version the driver of the peripheral device and flash the firmware with the driver, such that the driver of the peripheral devices of the embedded system development board 101 can be automatically updated.

In the abovementioned embodiment, the CMOS sensor is served as an example of peripheral device. People having ordinary skill in the art should know that peripheral devices have different types, such as electronic compass, Bluetooth receiver, etc. The present invention is not limited thereto.

In the abovementioned embodiment, the driver is packaged into a firmware and update whole firmware of the embedded system development board 101 as an example. The following embodiment provides a new partial update method.

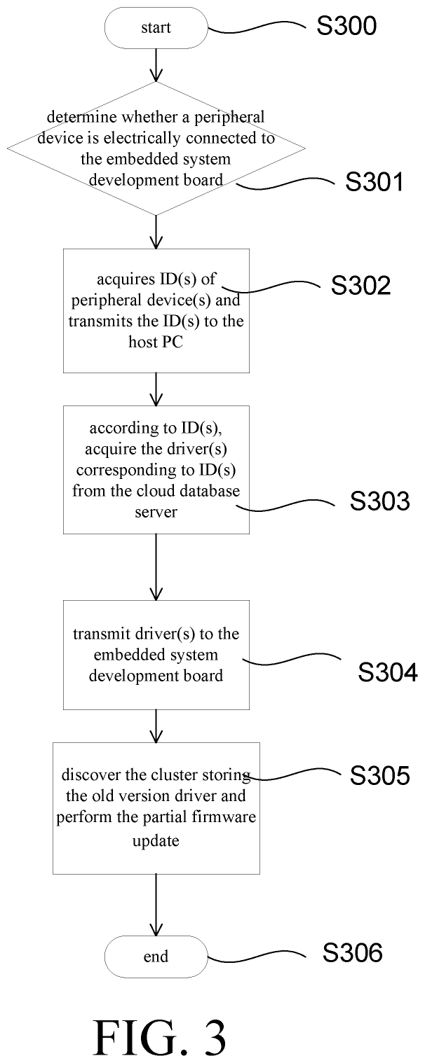

FIG. 3 illustrates a flow chart depicting an OS-independent peripheral plug-and-play and driver update method for embedded system according to a preferred embodiment of the present invention. Referring to FIG. 3, the OS-independent peripheral plug-and-play and driver update method includes the steps as follow.

In step S300, the method starts.

In step S301, it is determined whether a peripheral device is electrically connected to the embedded system development board 110.

In step S302, when a peripheral device is electrically connected to the embedded system development board 110, the embedded system development board 110 acquires the ID of the peripheral device and transmits the ID to the host PC 105. For example, user changes the CMOS sensor, the ID of the CMOS sensor would transmits to the development toolkits program of the host PC 105.

In step S303, according to the ID of the peripheral device, the driver corresponding to the ID is acquired from the cloud database server. The upgrade modules in the development toolkits program of the host PC 105 would search the driver in the cloud database server 106.

In step S304, the driver is transmitted to the embedded system development board 101.

In step S305, the cluster storing the old version driver is discovered and the driver update is performed such that the driver installation is complete. As mentioned above, the upgrade modules of the development toolkits program in the host PC 105 would transmits the driver to the embedded system development board 101. And the embedded system development board 101 replaces the driver according to the cluster storing the driver in the flash memory. Thus, the new version driver of the CMOS sensor is successfully updated, and the plug-and-play function is achieved. Because when the format of the flash memory is performed, the clusters in the flash memory are defined. Generally, the driver only occupy a small space, it almost cannot occupy a whole cluster of the flash memory. Therefore, if the cluster storing the driver is replaced by the new version driver, the driver update can be achieved.

In step S306, the method ends.

In the embodiment of the present invention, the assumption is that the CMOS sensor is replaced such that the driver should be updated. However, when a new version driver is provided in the cloud database server 106, the embodiment in FIG. 3 can also be used for updating driver. Thus, in the other preferred embodiment, when the host PC 105 acquires all ID of the peripheral devices, the host PC 105 would compare the drivers installed in the embedded system development board 101 with the driver in the loud database server 106. If a new version driver(s) is/are found, the step S303 is performed to acquire the new version driver(s) and then the steps S304 and S305 are performed to install the new version driver(s) into the corresponding cluster(s) of the flash memory.

In summary, the spirit of the invention is to perform the abovementioned steps, user only need to electrically connect the peripheral device to the embedded system development board, and the host PC can download the driver by a specific program according to the ID of the peripheral device. And then according to the requirement, the driver may be packaged in to a firmware for performing firmware update or be transmitted to the embedded system development board to perform a partial update. It is convenient for users to increase the development speed and also reduces the burden on developers.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. An OS-independent peripheral plug-and-play and driver update method for embedded system, comprising:
determining whether an embedded system development board is electrically connected to a host PC;
determining whether a peripheral device is electrically connected to the embedded system development board;
when the peripheral device is electrically connected to the embedded system development board, acquiring the ID code of the peripheral device;
connecting to a cloud database server;
according to the ID code of the peripheral device, acquiring a driver of the peripheral device from the cloud database server; and
performing a firmware update for the embedded system development board.

2. The OS-independent peripheral plug-and-play and driver update method for embedded system according to claim 1, wherein the peripheral device comprises:
a CMOS sensing module.

3. The OS-independent peripheral plug-and-play and driver update method for embedded system according to claim 1, wherein performing a firmware update for the embedded system development board comprises:
packing a firmware with the driver, and transmitting the firmware to the embedded system development board; and
updating the embedded system development board by the firmware.

4. The OS-independent peripheral plug-and-play and driver update method for embedded system according to claim 1, wherein performing a firmware update for the embedded system development board comprises:
transmitting the driver to the embedded system development board through a update program; and
performing partial firmware update, wherein the driver in a cluster of a flash of the embedded system development board is updated.

5. A development system for embedded system, comprising:
an embedded system development board;
a host PC;
a cloud database server, for storing a plurality of drivers of peripheral devices;
wherein it is determined whether a peripheral device is electrically connected to the embedded system development board when a development board is electrically connected to the host PC;
wherein an ID of the peripheral device is acquired and a connection between the cloud database server and the host PC is built when the peripheral device is electrically connected to the embedded system development board;
wherein a driver is acquired from the cloud database server according to the ID of the peripheral device such that the firmware update is performed.

6. The development system for embedded system according to claim 5, wherein the peripheral device comprises:
a CMOS sensing module.

7. The development system for embedded system according to claim 5,
wherein the host PC packs a firmware with the driver and transmits the firmware to the embedded system development board;
wherein the embedded system development board performs the firmware update.

8. The development system for embedded system according to claim 5,
wherein the host PC transmits the driver to the embedded system development board;
wherein the embedded system development board performs a partial firmware update, wherein a cluster which stores an old version driver is updated with the driver.
